(19) United States
(12) Patent Application Publication
(10) Pub. No.: US 2016/0137203 A1
(43) Pub. Date: May 19, 2016

(54) METHOD AND DEVICE FOR OPERATING A VEHICLE

(71) Applicant: ROBERT BOSCH GMBH, Stuttgart (DE)

(72) Inventors: Martin Mueller, Ludwigsburg (DE); Florian Hauler, Linkenheim (DE); Stefan Kueperkoch, Heilbronn (DE); Jeannine Schwarzkopf, Ludwigsburg (DE); Stefan Nordbruch, Kornwestheim (DE); Oliver Pink, Stuttgart (DE)

(21) Appl. No.: 14/896,851

(22) PCT Filed: Apr. 14, 2014
(86) PCT No.: PCT/EP2014/057537

§ 371 Date: Dec. 8, 2015

(30) Foreign Application Priority Data
Jun. 11, 2013 (DE) 10 2013 210 883.4

(51) Int. Cl. B60W 30/18; B60W 40/09; B60W 10/04; B60W 10/18; B60W 10/20

(52) U.S. Cl. CPC B60W 30/18009; B60W 10/18; B60W 10/20; B60W 10/04; B60W 30/18163; B60W 40/09; B60W 2540/30; B60W 2710/18; B60W 2710/20; B60W 2720/10

(57) ABSTRACT

A method for operating a vehicle includes: detecting an intended strategy of a vehicle occupant for a driving strategy of the vehicle; comparing the intended driving strategy to a number of multiple possible driving strategies for a current driving situation of the vehicle; and controlling the vehicle as a function of a driving strategy that is selected based on the comparison to the number of possible driving strategies.

### BACKGROUND OF THE INVENTION

1. Field of the Invention

The present invention relates to a method, a computer program and a device for operating a vehicle based on a detected driver's intended driving strategy.

2. Description of the Related Art

Known driver-assistance systems usually specify a fixed driving strategy for a vehicle. Strategic driving wishes of a driver of the vehicle are normally not taken into account or only to a minimal extent. This may cause the driver to reject the use of the driver-assistance system or possibly to deactivate it, which could lead to critical situations.

### BRIEF SUMMARY OF THE INVENTION

The objective on which the present invention is based may be seen as providing a method for operating a vehicle that overcomes the known disadvantages and takes a driving strategy intention of a vehicle occupant into account, so that the use of the method will be accepted more readily.

The objective on which the present invention is based may therefore also be seen as providing a corresponding device for operating a vehicle.

Moreover, the object on which the present invention is based may also be seen as providing a corresponding computer program.

According to one aspect, a method for operating a vehicle is provided, the method including the following steps:
Detecting an intention of a vehicle occupant for a driving strategy of the vehicle,
Comparing the intended driving strategy to a number of multiple possible driving strategies for a current driving situation of the vehicle, and
Controlling the vehicle as a function of a driving strategy that is selected from the number of possible driving strategies as a function of the comparison.

According to one further aspect, a device for operating a vehicle is provided, which includes:
a detection device for detecting an intention of a vehicle occupant for a driving strategy of the vehicle,
a comparison device for comparing the intended driving strategy with a number of multiple possible driving strategies for a current driving situation of the vehicle, and
a control for controlling the vehicle as a function of a driving strategy that is selected from the number of possible driving strategies as a function of the comparison.

According to a still further aspect, a computer program is provided, which includes program code for executing the method for operating a vehicle when the computer program is run on a computer.

That is to say, the present invention in particular encompasses the idea of taking an intended driving strategy of a driver into account to the extent that it is compared to a selection from multiple possible driving strategies in relation to a current driving situation of the vehicle. The result of the comparison is then utilized as the basis for the selection of the driving strategy, which will then actually be employed for controlling the vehicle. The driver intention thus is at least indirectly taken into account when controlling the vehicle. This increases an acceptance by the vehicle occupant, especially the vehicle driver, and results in a greater likelihood that the vehicle occupant will not deactivate the device and will allow the execution of the method. This advantageously increases the safety of a vehicle.

Possible driving strategies within the meaning of the present invention in particular are driving strategies that are useful with regard to a current driving or traffic situation. Useful, for example, may mean that an evasive maneuver is performed in order to avoid a collision. That is to say, one possible or meaningful driving strategy in particular is a driving strategy that at least will not reduce, or in particular will increase, the safety for the vehicle, for the vehicle occupants, and/or for an environment of the vehicle.

In other words, the fact that a possible driving strategy is selected for the control, the selection of the specific driving strategy being performed as a function of the comparison, advantageously ensures greater safety.

According to one specific embodiment, the possible driving strategies are developed based on legal rules. These legal rules, for example, include traffic regulations. More specifically, the possible driving strategies are developed based on traffic rules currently to be obeyed, for instance speed limits and/or passing bans. The possible driving strategies in particular are formed in such a way that an endangerment of the vehicle occupant(s) is minimized or excluded.

According to one specific embodiment, the vehicle occupant may be the vehicle driver.

According to one specific embodiment, the vehicle occupant may be a passenger.

According to one specific embodiment, the driving strategy of the intended driving strategy of the vehicle occupant is used as the particular driving strategy on the basis of which the vehicle is controlled, provided it is determined in the comparison that one of the possible driving strategies corresponds to the driving strategy of the intended driving strategy. This advantageously further increases the acceptance of the use of the present invention by the vehicle occupant because in this case the desired driving strategy of the vehicle occupant is actually also carried out in this way.

According to one further specific embodiment, if none of the possible driving strategies corresponds to the desired driving strategy, the driving strategy that is most similar to the driving strategy of the desired driving strategy will be selected from the number of possible driving strategies for the control of the vehicle. Although the desired driving strategy is not implemented exactly, at least a driving strategy that is as similar as possible is used for the control of the vehicle. This, too, advantageously increases the acceptance.

Similar in this context in particular means that the desired driving strategy and the selected driving strategy are similar in at least one aspect, preferably in multiple aspects, with regard to a vehicle control. For instance, a driving strategy that includes an acceleration is not similar to a desired driving strategy that includes an intention to stop.

It may be provided to parameterize the driving strategies and to compare the individual parameters with each other in order to select the most similar driving strategy. The parameters, for example, may be provided with a weighting factor.

A driving strategy, for instance, may include a standard driving strategy that corresponds to a balanced mixture of driving comfort, energy efficiency and driving time.

One further driving strategy, for example, may be a time-saving driving strategy that attempts to minimize the driving time.

Another driving strategy may be a sporty driving strategy, for instance, which in particular allows greater accelerations and/or decelerations than the standard driving strategy, for instance.

One still further driving strategy may in particular be a defensive driving strategy, which allows an especially safe driving mode and avoids passing maneuvers, for instance.

A still further driving strategy, for example, may be a comfort driving strategy, which minimizes acceleration and/or deceleration maneuvers, in particular, and which allows vehicle occupants to work in an especially comfortable manner.

One driving strategy, for example, may be an economy driving strategy, which minimizes an energy consumption, i.e., especially a fuel consumption and/or an electric energy consumption, for instance by extended rolling to a stop.

According to another specific embodiment, it may be provided that the number of multiple possible driving strategies is supplied for the selection of one of the plurality of possible driving strategies. That is to say, the vehicle occupant in particular is advantageously able to select one of the number of possible driving strategies. In other words, possible driving strategies that appear especially advantageous in the current driving situation are proposed to the vehicle occupant, especially the driver. For instance, the economy driving strategy is proposed when a fuel tank and/or an accumulator are/is nearly depleted. The comfort driving strategy, for example, is proposed when the current driving situation is a traffic jam, so that the vehicle occupants can advantageously work without interruption.

According to one specific embodiment, the supply of the number of multiple possible driving strategies for the selection of one of the multiple possible driving strategies is provided before the intended driving strategy is detected.

According to another specific embodiment, multiple vehicles may be provided and an individual comparison be carried out on a server that is formed separately in relation to the vehicles, so that an individual driving strategy for controlling the vehicles is generated for an adapted driving behavior of the vehicles, the generated driving strategies being transmitted to the corresponding vehicles. In an advantageous manner, the adjustment between intention and driving situation thus takes place centrally for the plurality of vehicles, on an external server, so that a behavior, i.e., a driving strategy, that is optimal for all vehicles and avoids traffic congestion, for instance, can be ascertained.

According to a still further specific embodiment, the possible driving strategies are formed based on sensor data from an environmental sensor system of the vehicles for the sensor-based detection of a vehicle environment. Environment sensors of the environmental sensor system, for instance, may include a temperature sensor, a rain sensor, a video sensor, a camera sensor, a radar sensor, and an ultrasonic sensor. Consequently, this in particular means that the current driving situation is able to be ascertained or recorded with the aid of the sensors of the environmental sensor system. The environmental sensor system in particular may include one environment sensor or a plurality of environment sensors.

According to another specific embodiment, the possible driving strategies are generated based on sensor data from a state sensor system of the vehicle for the sensor-based detection of a vehicle state. The state of the vehicle thus advantageously plays a role in connection with possible driving strategies.

According to one further specific embodiment, it may be provided that the state sensor system includes a tank level sensor for detecting a fill level of an energy storage device of the vehicle drive. An energy storage device for the drive, for example, includes a fuel tank and/or a vehicle battery, such as an accumulator. For instance, the fill level may advantageously be used for determining a maximum range of the vehicle. The maximum range may then advantageously be utilized as the basis for possible driving strategies, such as an economy driving strategy.

According to one specific embodiment, it may be provided that the state sensor system includes a pressure sensor for measuring a tire pressure. This advantageously makes it possible to generate a possible driving strategy based on a tire pressure. For instance, when the tire pressure is too low, a defensive driving strategy is usually more meaningful than a sporty driving strategy.

In one further specific embodiment, it may be provided that the possible driving strategies are generated based on weather data, in particular weather forecast data, and/or traffic data, e.g., congestion data and/or TMC (Traffic Message Channel) traffic data, and/or map data, especially map data of a digital map, and/or time of day data. These data may be provided as Cloud data, for instance. In other words, this in particular means that these data are provided on a Cloud and are retrievable from there.

In one further specific embodiment, the vehicle strategy includes vehicle maneuvers selected from the following group of vehicle maneuvers: an acceleration of the vehicle, an acceleration of the vehicle in order to attain a new vehicle setpoint speed, braking of the vehicle, braking of the vehicle in order to obtain a new vehicle setpoint speed, executing a lane change, executing a passing maneuver, executing a turn-off procedure, stopping, parking, driving faster, driving slower, lane change, especially a lane change as soon as possible, passing maneuver, especially a passing maneuver as quickly as possible, turning off into a particular direction, stopping, in particular stopping as soon as possible, parking, in particular parking as soon as possible, or a combination thereof.

In one specific embodiment, a man-machine interface may be provided. For example, such an interface may be used for selecting the driving strategy and/or for making the selection of possible driving strategies available.

According to one further specific embodiment, the man-machine interface may include a mechanical input device, in particular a steering wheel for generating a steering wheel torque, a joystick.

In one further specific embodiment, the man-machine interface may be developed for gesture control and/or for speech-based control.

In one other specific embodiment, the man-machine interface may include a neuronal interface, which advantageously enables a direct link to human nerve cells.

The present invention will be explained in greater detail in the following text with reference to preferred exemplary embodiments.

### BRIEF DESCRIPTION OF THE DRAWINGS

FIG. 1 shows a flow chart of a method for operating a vehicle.

FIG. 2 shows a device for operating a vehicle.

FIG. 3 shows a flow chart of a further method for operating a vehicle.

### DETAILED DESCRIPTION OF THE INVENTION

FIG. 1 shows a flow chart of a method for operating a vehicle.

According to a step 101, a desire of a vehicle occupant for a driving strategy of the vehicle is detected. According to a step 103, the desired driving strategy is compared to a number of multiple possible driving strategies for a current driving situation of the vehicle. According to a step 105, the vehicle is selected as a function of a driving strategy selected from the number of possible driving strategies.

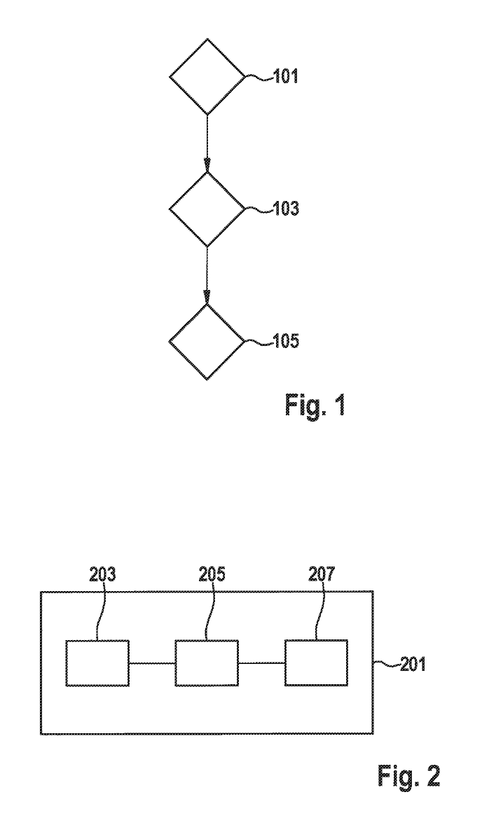

FIG. 2 shows a device 201 for operating a vehicle.

Device 201 includes a detection device 203 for detecting an intention of a vehicle occupant for a driving strategy of the vehicle,

Furthermore, a comparison device 205 for comparing the desired driving strategy to a number of multiple possible driving strategies for a current driving situation of the vehicle is provided. In addition, device 201 has a control 207 for controlling the vehicle as a function of a driving strategy that is selected from the number of possible driving strategies as a function of the comparison.

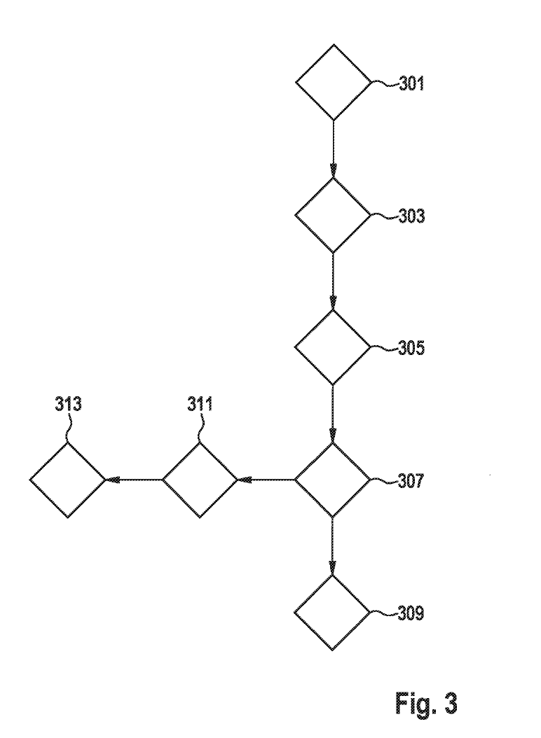

FIG. 3 shows a flow chart of a further method for operating a vehicle.

According to a step 301, possible driving strategies for a vehicle in relation to a current driving situation are generated based on sensor data from an environmental sensor system of the vehicle for the sensor-based detection of a vehicle environment. These possible driving strategies are furthermore generated in step 301 based on sensor data from a state sensor system of the vehicle for the sensor-based detection of a vehicle state. The state sensor system includes a fill level sensor for detecting a fill level of an energy storage device of the vehicle drive, so that a maximum range of the vehicle is able to be ascertained. This is done as a function of map data from a digital map of a navigation system, in particular.

In one exemplary embodiment, which is not shown, it may be provided to use still further data, which have already been described in the previous text, for instance, for calculating or generating the possible driving strategies.

In a step 303, the possible driving strategies are supplied for the selection, for instance with the aid of a man-machine interface. A vehicle occupant thus can advantageously select a driving strategy from the provided driving strategies.

In a step 305, a desired driving strategy of a vehicle occupant is detected, for instance with the aid of the man-machine interface.

In a step 307, the desired driving strategy is compared to the possible driving strategies.

The vehicle occupant will normally select one of the provided driving strategies, so that, according to a step 309, the vehicle is controlled based on the selected driving strategy.

However, if it is determined in step 307 that the desired driving strategy does not correspond to any of the driving strategies supplied, then a driving strategy that is most similar to the desired driving strategy and thus comes closest in particular to the specifications of the vehicle occupant with regard to a vehicle control will be selected from the number of supplied possible driving strategies, this selection taking place in a step 311.

In a step 313, the vehicle is controlled based on the driving strategy selected in step 311.

1-10. (canceled)

11. A method for operating a vehicle, comprising:
detecting, by a detection unit, a vehicle occupant's intended driving strategy for the vehicle;
comparing, by a comparison unit, the intended driving strategy to a multiple possible driving strategies for a current driving situation of the vehicle; and
controlling, by a control unit, the vehicle using a driving strategy which is selected from the multiple possible driving strategies as a function of the comparison.

12. The method as recited in claim 11, wherein the multiple possible driving strategies are supplied for the selection of one of the multiple possible driving strategies.

13. The method as recited in claim 11, wherein a server which is external to the vehicle performs the comparison of the intended driving strategy to the multiple possible driving strategies, in order to select a specific driving strategy for the control of the vehicle, and wherein the selected driving strategy is transmitted to the vehicle.

14. The method as recited in claim 11, wherein the multiple possible driving strategies are generated based on sensor data from an environmental sensor system of the vehicle for a sensor-based detection of a vehicle environment.

15. The method as recited in claim 11, wherein the multiple possible driving strategies are generated based on sensor data from a state sensor system of the vehicle for a sensor-based detection of a vehicle state.

16. The method as recited in claim 15, wherein the state sensor system includes a fill level sensor for detecting a fill level of an energy storage device of a vehicle drive.

17. The method as recited in claim 16, wherein the state sensor system includes a pressure sensor for measuring a tire pressure.

18. The method as recited in claim 14, wherein the multiple possible driving strategies include at least two of: accelerating the vehicle; accelerating the vehicle in order to attain a new vehicle setpoint speed; braking the vehicle; braking the vehicle in order to attain a new vehicle setpoint speed; executing a lane change; executing a passing maneuver; executing a turn-off operation; stopping; and parking.

19. A control device for operating a vehicle, comprising:
a detection device configured to detect a vehicle occupant's intended driving strategy for the vehicle;
a comparison unit configured to compare the intended driving strategy to a multiple possible driving strategies for a current driving situation of the vehicle; and
a control unit including a processor configured to control the vehicle using a driving strategy which is selected from the multiple possible driving strategies as a function of the comparison.

20. A non-transitory, computer-readable data storage medium storing a computer program including program codes which, when executed on a computer, perform a method for operating a vehicle, the method comprising:
detecting, by a detection unit, a vehicle occupant's intended driving strategy for the vehicle;
comparing, by a comparison unit, the intended driving strategy to a multiple possible driving strategies for a current driving situation of the vehicle; and
controlling, by a control unit, the vehicle using a driving strategy which is selected from the multiple possible driving strategies as a function of the comparison.
